(19) United States
(12) Patent Application Publication
(10) Pub. No.: US 2005/0127276 A1
(43) Pub. Date: Jun. 16, 2005

(54) Sensorblock

(76) Inventor: Hubert A. Hergeth, Rotkreuz (CH)

Correspondence Address: Proskauer Rose LLP, Room 17-25, 1585 Broadway, New York, NY, 10036, US

(21) Appl. No.: 10/965,487

(22) Filed: Oct. 14, 2004

(30) Foreign Application Priority Data
Oct. 17, 2003 (DE) 103 49 103.1

(51) Int. Cl. H01J 40/14; G01N 21/86

(52) U.S. Cl. 250/214 R; 250/559.01

(57) ABSTRACT

Housing for a long optical sensor system for the inspection of material taken past the sensor in batches. The sensor is made up of several boards on which the individual photosensitive elements are placed. The boards are adjusted and attached on at least one common support. The support is located in the housing.

The placement in a housing of several synthetic resin boards on which sensors are placed in order to provide a very wide optical sensor is known. It is customary to push the boards into guide grooves of an aluminum profile and to set the distance between boards in such manner by means of a spacing device so that the sensors on the boards and the sensor at the edges of the boards are at approximately the same distance from each other. In this embodiment it is however difficult to set the position of the board in the housing exactly and to correct the position of the boards relative to each other after the introduction of several boards.

It is the object of the invention to create an easily operated system for the production of the extra long optical sensors.

According to the invention this is achieved by screwing and aligning the individual boards with the light-sensitive silicon elements which essentially constitute the long sensor on at least one common support.

The boards are aligned on the support, e.g. an aluminum profile, in such manner that the photosensitive elements within a board and between two boards are at approximately the same distance from each other and are aligned approximately in one line.

Following their alignment, the boards are fixed in place, e.g. by screwing or gluing. The boards on the strip can then easily be tested electrically and optically before they are screwed to the supporting holder for the lens system and, if applicable, for illumination.

The support with the boards is then placed into an overall housing or is added to a housing.

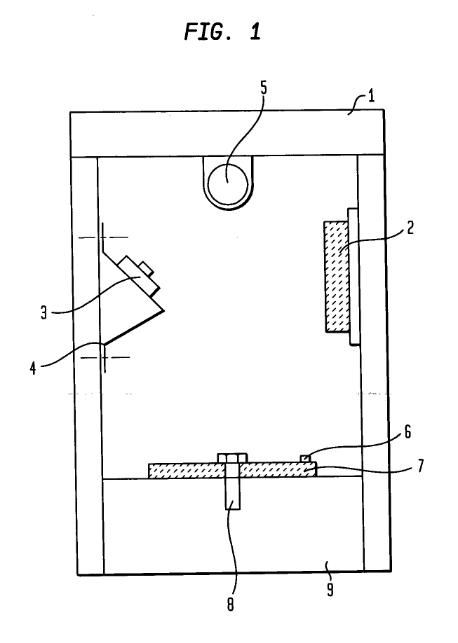

FIG. 1 shows a cross-section through a sensor housing. The batch of material to be examined slides along the glass pane 1. An LED illumination cell 3 mounted on a holder 4 in the housing illuminates the batch through a lens 5 and the glass 1. The reflected light is projected through a lens 2 upon the photosensitive elements 6. These elements are installed on a board 7. The board is fixed by means of screws 8 in a support 9. The support is part of the housing.

1. Sensor for the preferably two-dimensional observation of generally web-shaped material, whereby the optical sensor extends over a considerable portion of the object under observation and whereby several boards with aligned photosensitive elements are installed in a sensor housing, wherein at least two boards are adjusted and attached on a common support.

2. Sensor as in claim 1, wherein the boards are adjusted on the support outside the housing and in that the support is mounted in the housing after the adjustment.

3. Sensor as in claim 1, wherein the support is part of the housing.

4. Sensor as in claim 1, wherein the support, the outer housing walls, the lens system and transparent cover are permanently attached to each other.

5. Sensor as in claim 1, wherein a flat material or profile is used as support.
